(19) United States
(12) Patent Application Publication
(10) Pub. No.: US 2025/0105638 A1
(43) Pub. Date: Mar. 27, 2025

(54) ELECTRONIC APPARATUS FOR COMMUNICATION

(71) Applicant: OXTI Pte Ltd, Singapore (SG)

(72) Inventor: Chih-Feng Ho, Singapore (SG)

(21) Appl. No.: 18/474,150

(22) Filed: Sep. 25, 2023

(51) Int. Cl. H02J 7/00; A47B 21/00; H04N 7/14

(52) U.S. Cl. CPC H02J 7/0042; H04N 7/142; A47B 21/00

(57) ABSTRACT

An electronic apparatus for communication is provided, including an electronic device, which includes a control module, a charged section, and a combining section, the control module including a transmitting/receiving module, an image-capturing module, a sounding module, and a first display device, the sounding module including a speaker and a microphone, the image-capturing module, the sounding module, and the first display device being electrically connected with the transmitting/receiving module, the charged section including a storage battery, which is electrically connected with the transmitting/receiving module; and a holding base, which includes a charging section and a recessed cavity, the combining section being positionable in the recessed cavity, the charging section being connectable with the charged section for supplying electrical power to the electronic device.

### BACKGROUND OF THE INVENTION

### (a) Technical Field of the Invention

The present invention relates generally to an electronic apparatus, and more particularly to an electronic apparatus for communication.

### (b) Description of the Prior Art

Taiwan Patent No. 1749826 discloses a video device, which is capable of adjusting a height of a camera module to prevent being blocked by an obstacle, yet no collaborative mounting support is provided, so that when it is hit, it may easily tip down to get damaged. It is also impossible to recharge wirelessly, making it easily running out of electrical power and needing to seek for a power outlet for recharging.

### SUMMARY OF THE INVENTION

In view of the above problem, an objective of the present invention is to provide an electronic apparatus for communication.

To fulfill the above objective, the present invention provides an electronic apparatus for communication, which comprises:
an electronic device, the electronic device comprising a control module, a charged section, and a combining section, wherein the control module comprises a transmitting/receiving module, an image-capturing module, a sounding module, and a first display device; the sounding module includes a speaker and a microphone; the image-capturing module, the sounding module, and the first display device are all electrically connected with the transmitting/receiving module; the charged section includes a storage battery, and the storage battery is electrically connected with the transmitting/receiving module; and
a holding base, the holding base comprising a charging section and a recessed cavity, wherein the combining section is positionable in the recessed cavity, and the charging section is connectable with the charged section to achieve an effect of supplying electrical power to the electronic device, the holding base being provided with a charging hole, the charging hole being connectable with utility power.

Positioning the combining section of the electronic device in the recessed cavity of the holding base makes the electronic device not be easily hit to tip down, and also allows the electronic device to be recharged, while in operation, by means of the charged section and the charging section, to thereby extend the operation time thereof.

### BRIEF DESCRIPTION OF THE DRAWINGS

FIG. 1 is a perspective view showing a combination of an electronic device and a fixing base according to the present invention.

FIG. 2 is an exploded view showing the electronic device, the fixing base, and a support stand according to the present invention.

FIG. 3 is a block diagram illustrating an interior arrangement of the electronic device according to the present invention.

FIG. 3A is a block diagram illustrating a current conversion circuit according to the present invention.

FIG. 4 is a schematic view showing a rotary device arranged internally of the electronic device according to the present invention.

FIG. 5 is a schematic view illustrating a practical application of the present invention.

### DETAILED DESCRIPTION OF THE PREFERRED EMBODIMENTS

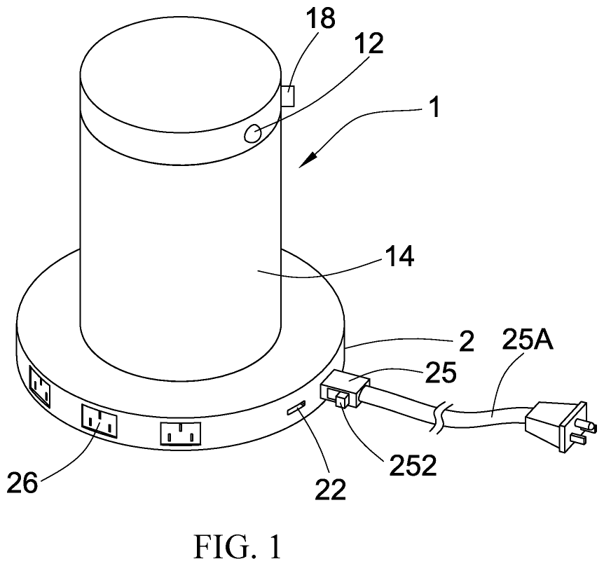

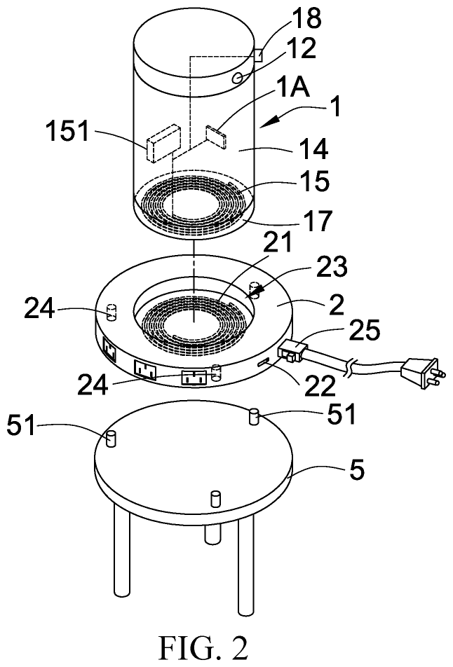

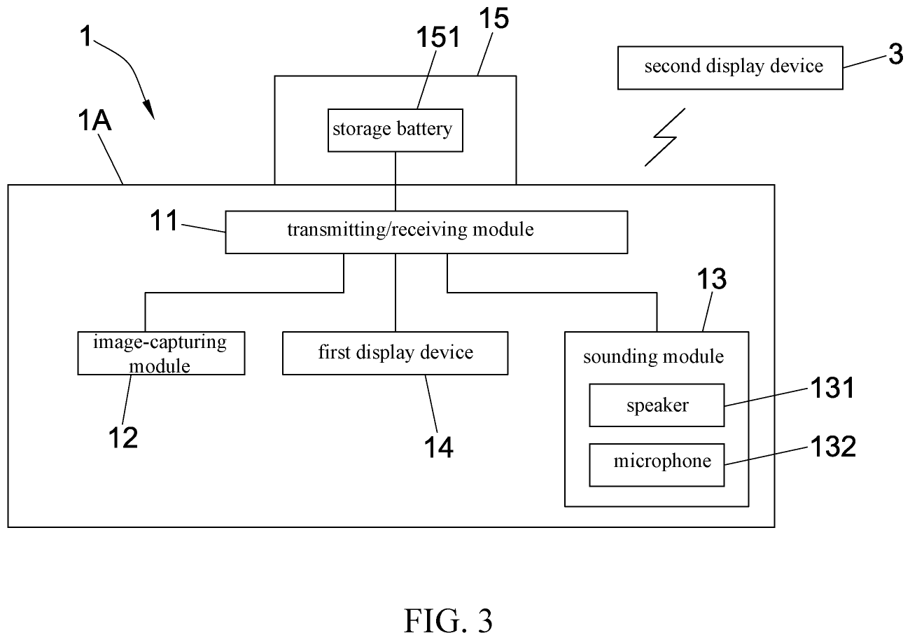

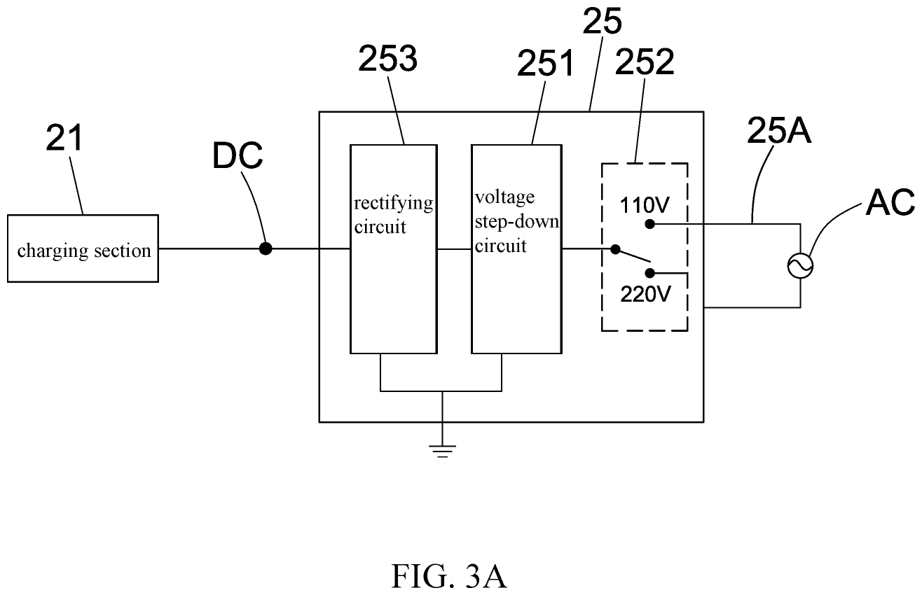

Referring to FIGS. 1 and 2, an electronic apparatus for communication is provided, comprising:
an electronic device 1, the electronic device 1 including a control module 1A, a charged section 15, and a combining section 17 and an ON/OFF switch 18, wherein the control module 1A comprises a transmitting/receiving module 11, an image-capturing module 12, a sounding module 13, and a first display device 14; the sounding module 13 is provided therein with a speaker 131 and a microphone 132; the image-capturing module 12, the sounding module 13, and the first display device 14 are all electrically connected with the transmitting/receiving module 11; and the charged section 15 is provided therein with a storage battery 151, and the storage battery 151 is electrically connected with the transmitting/receiving module 11, as shown in FIGS. 2 and 3; and
a holding base 2, the holding base 2 including a charging section 21 and a recessed cavity 23, wherein the combining section 17 is positionable in the recessed cavity 23, and the charging section 21 is connectable with the charged section 15 to achieve an effect of supplying electrical power to the electronic device 1, and the holding base 2 is provided with a charging hole 22, and the charging hole 22 is connectable to utility power.

Further, the holding base 2 may also include a current conversion circuit 25 and a plug 25A. The plug 25A is electrically connected to the current conversion circuit 25. The current conversion circuit 25 includes a voltage step-down circuit 251, a change-over switch 252, and a rectifying circuit 253. The change-over switch 252 is electrically connected with the voltage step-down circuit 251; the voltage step-down circuit 251 is electrically connected with the rectifying circuit 253; and the rectifying circuit 253 is electrically connected with the charging section 21, so that when utility power (alternating current, AC) is supplied through the plug 25A into the current conversion circuit 25, the change-over switch 252 may carry out a changeover operation according to the input current being 110V or 220V, which is then processed by the voltage step-down circuit 251 to step down to a desired voltage so as to finally feed through the rectifying circuit 253 to change the alternating current AC into a direct current DC to be transmitted to the charging section 21, as shown in FIGS. 1 and 3A.

In the electronic apparatus for communication, the holding base 2 may further include connected portions 24.

In the electronic apparatus for communication, the ON/OFF switch 18 is electrically connected between the storage battery 151 and the control module 1A, and the ON/OFF switch 18 controls whether electrical power is transmitted from the storage battery 151 to the control module 1A.

The present invention may further comprise a support stand 5, and the holding base 2 is positionable on the support stand 5. The support stand 5 includes connecting portions 51, and the connecting portions 51 are complementary to and matching up with the connected portions 24, so that the support stand 5 functions to elevate up the holding base 2 and the electronic device 1 to allow the image-capturing module 12 to picture a tall person, and to allow, in case of a crowd of persons being present, the first display device 14 to be easily watched by the persons. When it is not desired to use the support stand 5, the holding base 2 and the electronic device 1 can be directly positioned on a desk.

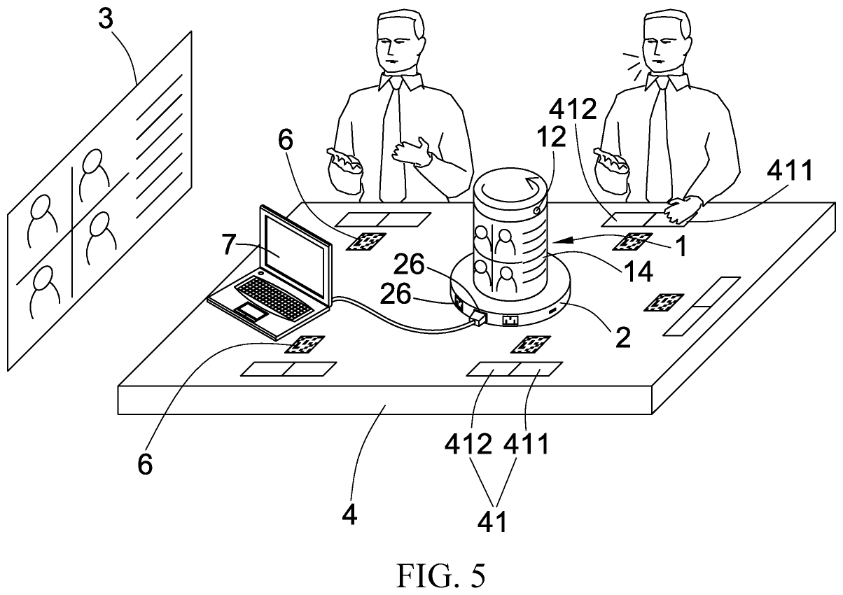

Referring to FIGS. 1 and 5, the holding base 2 is provided with at least one group of second charging holes 26, so that in the course of remote video conference, if a tool (such as a notebook computer 7) in hand is running out of electrical power, the notebook computer 7 can be recharged by plugging a charging cord thereof into the second charging holes 26.

Referring to FIGS. 3 and 5, during the course of a remote video conference, the storage battery 151 supplies electrical power to the transmitting/receiving module 11, and the transmitting/receiving module 11 in turn provides electrical power to the image-capturing module 12, the sounding module 13, and the first display device 14, and the transmitting/receiving module 11 may receive a signal transmitted from the other side to have an image thereof displayed on the first display device 14 and to have sounds thereof broadcast through the speaker 131 of the sounding module 13, and an image captured by the image-capturing module 12 and sounds captured by the microphone 132 of the sounding module 13 are transmittable through the transmitting/receiving module 11 to persons at the other side to thereby achieve an effect of video communication.

The present invention may further comprise a second display device 3, and the second display device 3 is connected, in a weird or wireless manner, to the electronic device 1 to have the image from the other side simultaneously displayed on the first display device 14 and the second display device 3. In case of multiple persons participating the conference communication, then some of the persons, who are not capable to clearly watch the image displayed on the first display device 14, may turn to watching the second display device 3.

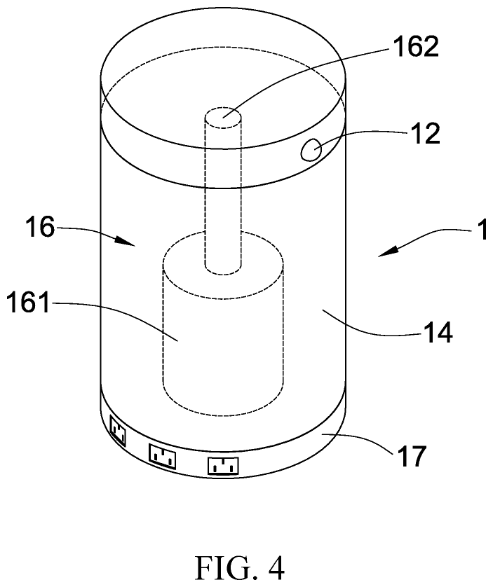

Referring to FIGS. 4 and 5, the electronic device 1 may include a rotary device 16. The rotary device 16 includes a motor 161 and a rotating axle 162. The motor 161 is connected to the rotating axle 162, and the rotating axle 162 is connected to the image-capturing module 12, and the rotary device 16 is electrically connected with the transmitting/receiving module 11, and the motor 161 is operable to drive the rotating axle 162, such that the rotating axle 162 drives the image-capturing module 12 to rotate leftward and rightward.

The present invention may comprise a desk 4, and the electronic device 1 and the holding base 2 are positioned on the desk 4. The desk 4 is provided with multiple groups of pushbuttons 41, and each group of pushbuttons 41 includes a first pushbutton 411 and a second pushbutton 412. When one of the first pushbuttons 411 is pushed for purposes of speaking, the first pushbutton 411 issues a signal to the electronic device 1, and the transmitting/receiving module 11 of the electronic device 1, upon receiving the signal, transmitting it to the rotary device 16 to use the rotary device 16 to rotate the image-capturing module 12 to a position corresponding to the one of the first pushbuttons 411 that is pushed, and after the speaking, the second pushbutton 412 is pushed to notify the other persons, and as such an effect of notifying the other persons of the operator's need for speaking and reminding the other persons to keep silent.

The present invention may further comprise a two-dimensional barcode 6 (such as a quick response code (QR code)). The two-dimensional barcode 6 can be arranged on the desk 4 or at any desired site, so that the two-dimensional barcode 6 can be scanned with an electronic product, such as a mobile phone or a tablet computer, to allow the operator to conduct operation with the mobile phone or the tablet computer, which may be operated in synchronous with operation performed with the pushbuttons 41.

Referring to FIG. 2, the combining section 17 of the electronic device 1 is received and retained in the recessed cavity 23 of the holding base 2 to achieve an effect of stably and securely holding the electronic device 1, so as to greatly reduce the chance of tipping down by being hit, and also to allow the electronic device 1 to be recharged while operated by means of the charged section 15 of the electronic device 1 and the charging section 21 of the holding base 2, to thereby extend the operation time period of the electronic device 1 without causing interruption during an operation of communication, and also to allow the device to serve as a mobile ornamental while not in use, and also allow the electronic device 1 and the holding base 2 to be stowed separately so as not to occupy a large space.

I claim:

1. An electronic apparatus for communication, comprising:
an electronic device, the electronic device comprising a control module, a charged section, and a combining section, wherein the control module comprises a transmitting/receiving module, an image-capturing module, a sounding module, and a first display device; the sounding module includes a speaker and a microphone; the image-capturing module, the sounding module, and the first display device are all electrically connected with the transmitting/receiving module; the charged section includes a storage battery, and the storage battery is electrically connected with the transmitting/receiving module; and
a holding base, the holding base comprising a charging section and a recessed cavity, wherein the combining section is positionable in the recessed cavity, and the charging section is connectable with the charged section to achieve an effect of supplying electrical power to the electronic device.

2. The electronic apparatus for communication according to claim 1, wherein the holding base comprises a charging hole, and the holding base comprises a connected portion.

3. The electronic apparatus for communication according to claim 1, further comprising a second display device and a support stand, wherein the second display device is connected, in a wired or wireless manner, to the electronic device, and the support stand comprises a connecting portion.

4. The electronic apparatus for communication according to claim 1, wherein the electronic device comprises an ON/OFF switch and a rotary device, and the rotary device comprises a motor and a rotating axle, and the motor is connected to the rotating axle and the rotating axle is connected to the image-capturing module.

5. The electronic apparatus for communication according to claim 1, further comprising a desk and a two-dimensional barcode, wherein the electronic device and the holding base are positionable on the desk, and the desk is provided with multiple groups of pushbuttons, and each group of the multiple groups of pushbuttons comprises a first pushbutton and a second pushbutton.

6. The electronic apparatus for communication according to claim 1, wherein the holding base comprises a current conversion circuit and a plug, and the plug is electrically connected with the current conversion circuit, and the current conversion circuit comprises a voltage step-down circuit, a change-over switch, and a rectifying circuit, wherein the change-over switch is electrically connected with the voltage step-down circuit, and the voltage step-down circuit is electrically connected with the rectifying circuit, and the rectifying circuit is electrically connected with the charging section.

7. The electronic apparatus for communication according to claim 1, wherein the holding base comprises at least one group of second charging holes.
